(19) United States
(12) Patent Application Publication
(10) Pub. No.: US 2024/0068222 A1
(43) Pub. Date: Feb. 29, 2024

(54) SIPHONIC WATER CLOSET PAN

(71) Applicant: Wallgate Limited, Salisbury (GB)

(72) Inventors: Richard DENBURY, Salisbury (GB); Alexander John GENT, Salisbury (GB)

(21) Appl. No.: 18/457,970

(22) Filed: Aug. 29, 2023

(30) Foreign Application Priority Data
Aug. 30, 2022 (GB) 2212548.8

(51) Int. Cl. E03D 11/18

(52) U.S. Cl. CPC E03D 11/18

(57) ABSTRACT

A siphonic water closet pan is disclosed that includes a bowl having a smooth convex rim, a water inlet passage connected to a water inlet to direct water into the bowl for flushing, a refill passage in fluid connection with the water inlet passage to allow water to refill the bowl after flushing, an outlet passage connected to an outlet for removal of waste, and a siphonic bypass connecting the outlet passage and the water inlet passage. The pan may further include a water reservoir in fluid connection with the refill passage. A barrier may be located between the water inlet and water inlet passage. The water closet pan is anti-ligature and anti-vandalism. Also disclosed is a process for producing the pan, a water closet comprising the pan, and a sanitary installation comprising one or more pans.

### FIELD

The present disclosure relates to water closet pans, in particular water closet pans for use in sanitary installations and institutions. The present disclosure also relates to processes for producing such water closet pans; to water closets comprising water closet pans; and to sanitary installations comprising one or more such water closet pans or water closets.

### BACKGROUND

Water closet pans, as described, for example, in GB-A-2,404,927 and other sanitary ware in public, and especially in secure, institutions can be subject to vandalism. GB-A-2,353,967 discusses a molding tool for use in producing a vandal resistant WC-pan.

Inmates in secure institutions occasionally use sanitary ware to self-harm, which may involve using parts of the sanitary ware as purchase points including for ligatures.

It is important, therefore, that sanitary ware is anti-ligature, i.e. that it is designed and constructed to reduce or eliminate the potential for use as a point of purchase for ligatures taking into account the items generally available to inmates in secure institutions. Sanitary ware for secure institutions should, in any event, be designed and constructed to reduce any potential for its misuse to harm persons in the institution. Sanitary ware should also be durable and resistant to vandalism including being fire-resistant.

WO-A-2010/013030 discloses lavatory pans, processes for producing such lavatory pans and molds for use in such processes. The lavatory pans have a wash-down flushing action, are anti-ligature and are particularly useful for secure institutions.

It is advantageous that sanitary ware in institutions does not give an institutional appearance to users. This may occur if visible parts of the sanitary ware are metallic, for example if the bowl of a water closet is uncoated stainless steel. It is also important that the flushing action of the water closet is relatively efficient to provide good standards of hygiene and to ensure odor control is maintained, whilst ensuring that water is conserved as much as possible.

US-A-2012/260415 discloses a thermoplastic pan for water saving which uses a siphonic action but which is intended to be easy to disassemble and so is of limited utility for institutions and locations that may be subject to vandalism.

It is difficult to ensure that both the anti-ligature and anti-vandalism problems are addressed, that efficient flushing is provided and that the water closet does not have an institutional appearance. Although vandal-resistant water closet pans have been manufactured, improvements are nonetheless required.

It is an aim of the present disclosure to address these problems.

### SUMMARY

The present disclosure accordingly provides, in a first aspect, a siphonic water closet pan, the water closet pan comprising: a bowl having a smooth convex rim, a water inlet passage connected to a water inlet to direct water into the bowl for flushing, a refill passage in fluid connection with the water inlet passage to allow water to refill the bowl after flushing, an outlet passage connected to an outlet for removal of waste, and a siphonic bypass connecting the outlet passage and the water inlet passage.

Preferably, the siphonic bypass is entirely enclosed within the material of the water closet pan. This is advantageous because it reduces the chance that exposed parts of the pan can be used as purchase points for ligatures or that internal components of the pan may be broken off or otherwise damaged.

The siphonic bypass may comprise a separate siphonic bypass pipe incorporated in the water closet pan during manufacture. Preferably, the siphonic bypass pipe is bonded to the outlet passage. Furthermore, the siphonic bypass pipe may be bonded to the water inlet passage.

The water inlet may be located to direct flushing water into the rear of the pan.

Preferably, the pan further comprises a barrier or barrier fitting located within the water inlet passage between the water inlet (to direct water into the bowl for flushing) and the refill passage. This is beneficial because it may prevent ligatures and contraband being inserted up the water passage. Optionally, the barrier fitting may provide a diverter to direct water around the bowl to improve hygiene.

Preferably, the barrier may be entirely enclosed within the material of the water closet pan. As discussed above for other components, this is advantageous because it reduces the chance that the barrier fitting can be used as a purchase point for ligatures or broken or otherwise damaged.

Preferably, the barrier is fixed in position, optionally adhesively bonded, cast-in-place, welded or solvent-welded in position.

The bowl water inlet may be located in the upper portion of the bowl to provide a wash-down action when water flows into the bowl after flushing.

The water inlet passage may be entirely or partially enclosed within the material of the water closet pan. Again, this is advantageous because it reduces the chance that ligatures can be passed up the passage to act as a purchase point or that it may be broken or otherwise damaged.

The outlet may usually be located in the base portion of the bowl.

The outlet passage may be entirely or partially enclosed within the material of the water closet pan. Again, this is advantageous because it reduces the chance that contraband or ligatures can be passed into the passage to act as a purchase point or that it may be damaged.

The refill passage is preferably connectable to a source of water for refilling the bowl. The source of water may be a mains or other supply. Preferably, the source of water comprises a water reservoir which may improve the speed of refilling of the bowl after flushing. Preferably, therefore, the pan further comprises a water reservoir. More preferably, the water reservoir is in fluid connection with the refill passage. The refill passage may form part of the water reservoir.

The outlet passage may be connectable to a waste pipe. Preferably, the waste pipe comprises a metal and more preferably comprises stainless steel. This is advantageous for robustness.

Usually, the waste pipe is connectable to a drain.

Preferably, the smooth convex rim is adapted so that it does not provide a purchase point. More preferably, the smooth convex rim has no undercuts that may form a purchase point.

Preferably, the pan is adapted for use without a separate seat because a seat may allow fixing of ligatures. Fixing portions in the pan for fixing a seat are also not preferred for similar reasons.

The pan may comprise resin, preferably plastics resin. More preferably the pan may comprise a cast resin, most preferably a polyester or polyurethane resin

It is preferred that the resin includes a fire-retardant material.

Water closet pans according to the present disclosure may be molded and cast from a polymer resin.

Thus, in a second aspect, the present disclosure accordingly provides a process for producing a siphonic water closet pan, the process comprising,
a) providing a mold, the components of the mold comprising
   i) a bowl former,
   ii) a water inlet former for forming a water inlet connected to water inlet passage to direct water into the bowl for flushing,
   iii) an outlet former for forming an outlet connected to an outlet passage for removal of waste, and
   iv) a bypass former for forming a siphonic bypass connecting the outlet passage and the water inlet passage.
b) filling the mold with a molding composition,
c) curing the molding composition, and optionally
d) disassembling the mold.

The bypass former may comprise a separate siphonic bypass pipe, optionally formed of a polymer.

Water closet pans may be connected to a waste drain and water supply.

Thus, in a third aspect, there is provided a water closet comprising a siphonic water closet pan according to the first aspect, wherein the refill passage is connected to a source of water for flushing, and the outlet passage is connected to a waste pipe which is connected to a drain.

Sanitary installations may have one or more water closets installed.

Therefore, in a fourth aspect, there is provided a sanitary installation comprising one or more siphonic water closet pans according to the first aspect or one or more water closets according to the third aspect.

Sanitary installations may include public lavatories, institutions (such as hospitals) or secure institutions (such as prisons and correctional facilities).

### BRIEF DESCRIPTION OF THE DRAWINGS

The present disclosure will now be described with reference to the accompanying drawings, in which:

FIG. 1 shows a water closet pan according to a first embodiment of the present disclosure with (a) a top plan view, (b) front perspective view, (c) a rear perspective view, (d) a front view and (e) a section on A-A of FIG. 1(d).

FIG. 2 illustrates in (a) a rear perspective view and in (b) a sectional view, a second embodiment of a water closet pan according to the present disclosure.

FIG. 3 illustrates details of the embodiment of the water closet pan as illustrated in FIG. 1 with (a) a section view, (b) a detail of the part circled in B in FIG. 3(a) and, (c) a detail of the part indicated as C in FIG. 3(a).

FIG. 4 shows a third embodiment of a water closet pan according to the present disclosure with the waste pipe extending below the pan.

FIG. 5 shows a fourth embodiment of a water closet pan according to the present disclosure with the waste pipe extending from the rear of the pan

### DETAILED DESCRIPTION

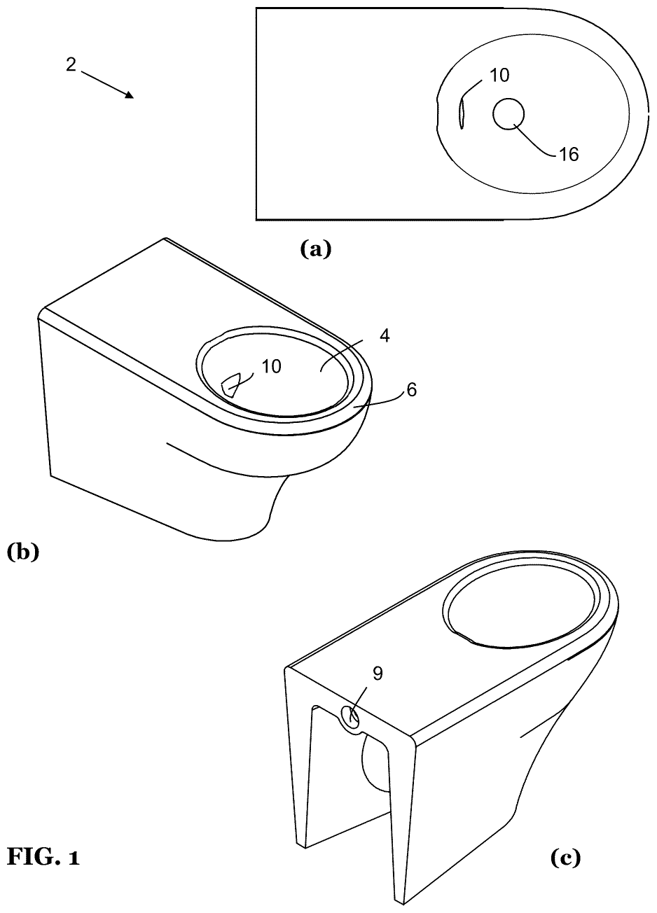

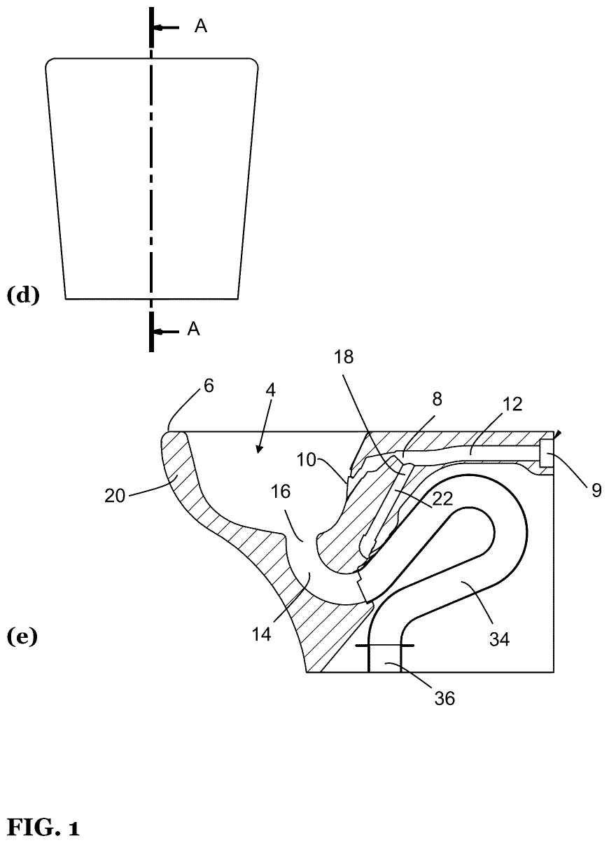

A water closet pan according to the present disclosure in a first embodiment is illustrated in FIG. 1(a) to (e).

The water closet pan 2 comprises a bowl 4 with a smooth, convex rim 6 at the top of the bowl 4. By “smooth” is meant that there are no protrusions, undercuts or other surface textures or structures/features that could form purchase points. There are no fittings for a seat or other attachment that may form a ligature purchase point. At the rear of the pan there is a connector 9 to a water supply that leads to a refill passage 12 and to a water inlet passage 8 which is in fluid connection with the bowl water inlet 10 through which water flows into the bowl 4. Towards the base portion of the bowl 4, there is a bowl outlet 16 by which waste is removed from the water closet pan 2.

In FIG. 1(e), the internal components of the pan are shown. The material 20 of the water closet pan 2 may be a polyester resin, preferably with fire retardant properties (this may be achieved by adding a fire retardant to the polyester resin before casting).

Waste leaves the bowl 4 through outlet passage 16 on flushing, passing through the outlet passage 14 and into the waste pipe 34. The waste pipe 34 is preferably stainless steel for robustness and is connected to the outlet passage 14 by a connector. The waste pipe 34 is connected to the drain by connector to the drain 36.

Towards the top, rear of the bowl 4 there is a bowl water inlet 10 (through which water enters the bowl 4) which is connected to the water inlet passage 8 and then in fluid connection to the refill passage 12. The refill passage may be connected to a source of water at the water outlet connector 9.

Between the water inlet passage and the waste pipe 34 there is a siphonic bypass 18 which may comprise a separate siphonic bypass pipe 22 incorporated in the water closet pan 2 during molding.

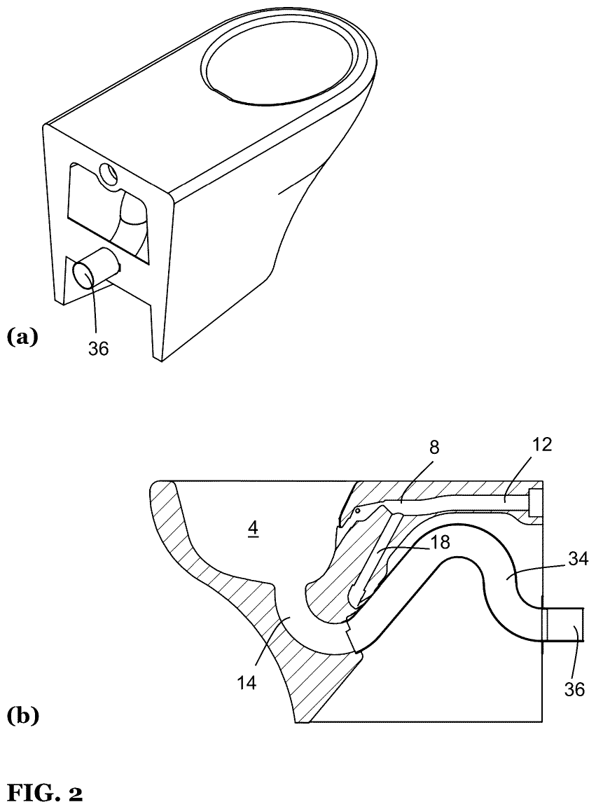

FIG. 2 illustrates a second embodiment of the water closet pan with, in this case, the waste pipe 34 being directed to the rear of the water closet pan in order to allow for a different connection in the facility. Otherwise the features indicated in FIG. 2 correspond to the same features in FIG. 1 and will not be described in further detail.

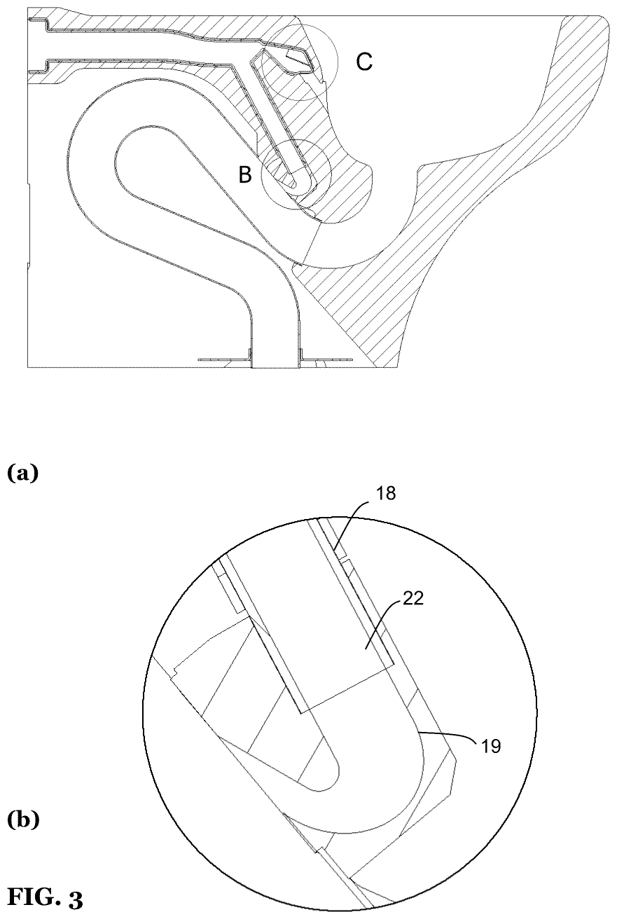

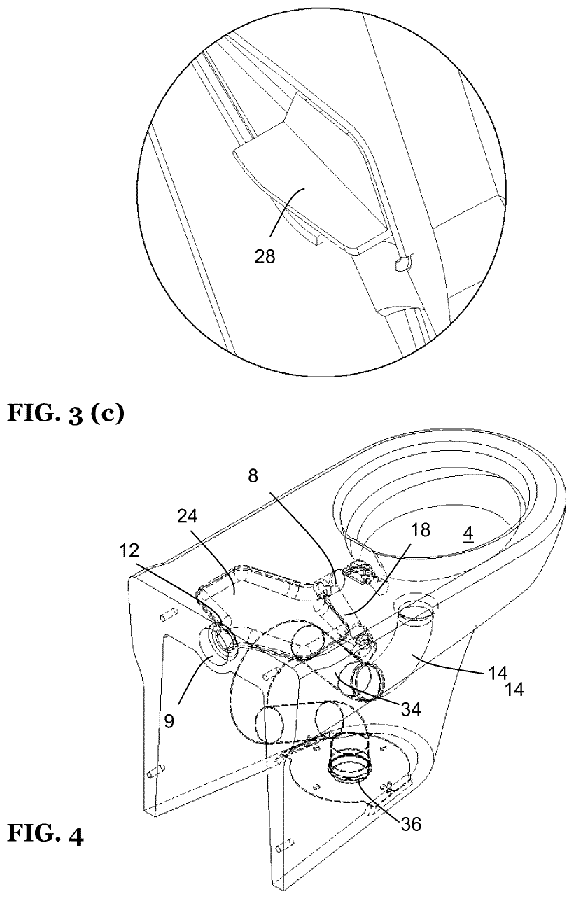

FIG. 3 illustrates some details of the embodiments of the water closet pan 2 as illustrated in FIG. 1. FIG. 3(a) is a section illustrating the internal components of the water closet pan 2. Detail B shows the connection between the waste pipe (not shown) and the siphonic bypass pipe 22 of the siphonic bypass 18. The connector includes a bypass fitting 19 cast into the solid surface of the material of the water closet pan 2. FIG. 3(c) illustrates the detail C in FIG. 3 (a) and shows a barrier fitting 28 which is welded (e.g. solvent welding) on to the appropriate point of the water inlet passage 8 close to the bowl water inlet 10. The purpose of the barrier 28 is to prevent the use of a bowl water inlet 10 to hide contraband or to act as a purchase point for ligatures by inmates in a facility. The barrier 28 may be formed of any suitable material, for example, metal.

FIG. 4 illustrates a third embodiment of a water closet pan according to the present disclosure. The components of the water closet pan are similar to those illustrated in FIG. 1, however there is an additional component of a water reservoir 24 which is in fluid connection with the refill passage 12 and allows water to be stored and then run into the bowl after the water closet pan has been flushed.

Once installed, the water closet pan will have the waste pipe 34 connected through connector 36 to a drain below the water closet. The water connector 9 will be connected to a source of water in order to provide water to refill the bowl 4 after flushing.

When the flush (not shown) is activated the siphonic action allowed by siphonic bypass 18 draws waste from bowl 4 through the bowl outlet 16 and to waste. Water through refill passage 12 and water inlet passage 8 refills the bowl 4 ready for the next flush. In the case of the embodiment illustrated in FIG. 4, this water may be supplied from water reservoir 24 which is itself refilled during the flushing cycle; the water reservoir 24 fills from the source of water and then slowly delivers a proportion of the water, after the flush, to refill the pan.

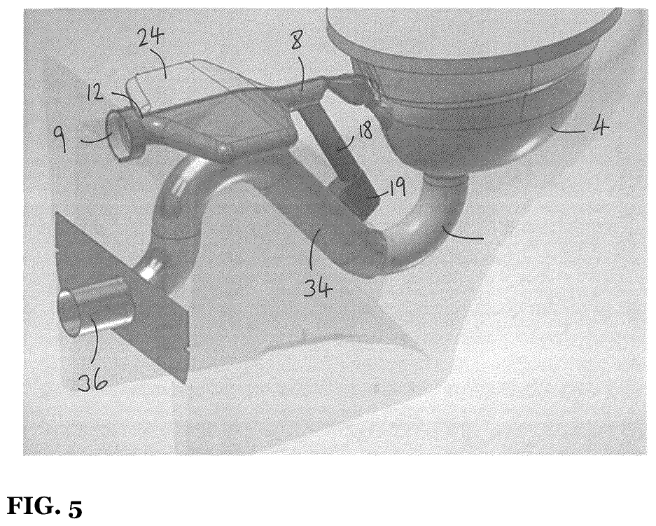

FIG. 5 illustrates a fourth embodiment of a water closet pan according to the present disclosure similar to FIG. 4 but in this case the waste pipe 34 extends to the rear of the pan. The components of the water closet pan are similar to those illustrated in FIG. 2, however there is an additional component of a water reservoir 24 which is in fluid connection with the refill passage 12 and allows water to be stored and then run into the bowl after the water closet pan has been flushed.

Once installed, the water closet pan will have the waste pipe 34 connected through connector 36 to a drain. The water connector 9 will be connected to a source of water in order to provide water to refill the bowl 4 after flushing.

When the flush (not shown) is activated the siphonic action allowed by siphonic bypass 18 draws waste from bowl 4 through the bowl outlet 16 and to waste. Water through refill passage 12 and water inlet passage 8 refills the bowl 4 ready for the next flush.

In the case of the embodiment illustrated in FIG. 5, this water may be supplied from water reservoir 24 which is itself refilled during the flushing cycle; the water reservoir 24 fills from the source of water and then slowly delivers a proportion of the water, after the flush, to refill the pan.

### REFERENCE NUMERALS

2 water closet pan
4 bowl
6 rim of bowl
8 water inlet passage
9 water inlet connector
10 bowl water inlet
12 refill passage
14 outlet passage
16 bowl outlet
18 siphonic bypass
19 bypast fitting
20 material of water closet
22 siphonic bypass pipe
24 water reservoir
28 barrier fitting
34 waste pipe
36 drain connector

All publications mentioned in the above specification are herein incorporated by reference. Although illustrative embodiments of the present disclosure have been disclosed in detail herein, with reference to the accompanying drawings, it is understood that the present disclosure is not limited to the precise embodiment and that various changes and modifications can be performed therein by one skilled in the art without departing from the scope of the present disclosure as defined by the appended claims and their equivalents.

The enumerated paragraphs below describe additional aspects, features, and combinations of the present disclosure.

A1. A siphonic water closet pan, the water closet pan comprising:
a bowl having a smooth convex rim,
a water inlet passage connected to a water inlet to direct water into the bowl for flushing,
a refill passage in fluid connection with the water inlet passage to allow water to refill the bowl after flushing,
an outlet passage connected to an outlet for removal of waste, and
a siphonic bypass connecting the outlet passage and the water inlet passage.
A2. The siphonic water closet pan of A1, wherein the siphonic bypass is entirely enclosed within the material of the water closet pan.
A3. The siphonic water closet pan of A2, wherein the siphonic bypass comprises a separate siphonic bypass pipe incorporated in the water closet pan during manufacture.
A4. The siphonic water closet pan of A3, wherein the siphonic bypass pipe is bonded to the outlet passage.
A5. The siphonic water closet pan of A3 or A4, wherein the siphonic bypass pipe is bonded to the water inlet passage.
A6. The siphonic water closet pan of any one of A1 through A5, further comprising a water reservoir in fluid connection with the refill passage.
A7. The siphonic water closet pan of any one of A1 through A6, wherein the water inlet is located to direct flushing water into the rear of the pan.
A8. The siphonic water closet pan of any one of A1 through A7, further comprising a barrier located between the water inlet and water inlet passage.
A9. The siphonic water closet pan of A8, wherein the barrier is fixed in position, optionally bonded, welded or solvent welded in position.
A10. The siphonic water closet pan of any one of A1 through A9, wherein the water inlet is located in the upper portion of the bowl.
A11. The siphonic water closet pan of any one of A1 through A10, wherein the water inlet passage is entirely or partially enclosed within the material of the water closet pan.
A12. The siphonic water closet pan of any one of A1 through A11, wherein the outlet is located in the base portion of the bowl.
A13. The siphonic water closet pan of any one of A1 through A12, wherein the outlet passage is entirely or partially enclosed within the material of the water closet pan.
A14. The siphonic water closet pan of any one of A1 through A13, wherein the refill passage is connectable to a source of water for flushing.
A15. The siphonic water closet pan of any one of A1 through A14, wherein the outlet passage is connectable to a waste pipe.
A16. The siphonic water closet pan of any one of A1 through A15, wherein the waste pipe comprises stainless steel.
A17. The siphonic water closet pan of any one of A1 through A16, wherein the waste pipe is connectable to a drain.
A18. The siphonic water closet pan of any one of A1 through A17, wherein the smooth convex rim is adapted so that it does not provide a purchase point.
A19. The siphonic water closet pan of any one of A1 through A18, wherein the pan is adapted for use without a separate seat.
A20. The siphonic water closet pan of any one of A1 through A19, wherein the pan comprises resin, preferably plastics resin, more preferably a cast resin, most preferably a polyester or polyurethane resin.
A21. The siphonic water closet pan of A20, wherein the resin includes a fire-retardant material.
B1. A process for producing a siphonic water closet pan, the process comprising,
   a) providing a mold, the components of the mold comprising
      i) a bowl former,
      ii) a water inlet former for forming a water inlet connected to water inlet passage to direct water into the bowl for flushing,
      iii) an outlet former for forming an outlet connected to an outlet passage for removal of waste, and
      iv) a bypass former for forming a siphonic bypass connecting the outlet passage and the water inlet passage.
   b) filling the mold with a molding composition,
   c) curing the molding composition, and optionally
   d) disassembling the mold.
B2. The process of B1, wherein the bypass former comprises a separate siphonic bypass pipe, optionally formed of a polymer.
C1. A water closet comprising the siphonic water closet pan of any one of A1 through A21, wherein the refill passage is connected to a source of water for flushing, and the outlet passage is connected to a waste pipe, and wherein the waste pipe is connected to a drain.
D1. A sanitary installation comprising one or more of the siphonic water closet pans of any one of A1 through A21, or one or more water closets of C1.

1. A siphonic water closet pan, the water closet pan comprising:
a bowl having a smooth convex rim,
a water inlet passage connected to a water inlet and configured to direct water into the bowl for flushing,
a refill passage in fluid connection with the water inlet passage and configured to allow water to refill the bowl after flushing,
an outlet passage connected to an outlet and configured to allow removal of waste, and
a siphonic bypass connecting the outlet passage and the water inlet passage.

2. The siphonic water closet pan of claim 1, wherein the siphonic bypass is entirely enclosed within a material of the water closet pan.

3. The siphonic water closet pan of claim 2, wherein the siphonic bypass comprises a separate siphonic bypass pipe incorporated into the water closet pan.

4. The siphonic water closet pan of claim 3, wherein the siphonic bypass pipe is bonded to the outlet passage.

5. The siphonic water closet pan of claim 3, wherein the siphonic bypass pipe is bonded to the water inlet passage.

6. The siphonic water closet pan of claim 1, further comprising a water reservoir in fluid connection with the refill passage.

7. The siphonic water closet pan of claim 1, wherein the water inlet is located and configured to direct flushing water into a rear of the pan.

8. The siphonic water closet pan of claim 1, further comprising a barrier located between the water inlet and the water inlet passage.

9. The siphonic water closet pan of claim 8, wherein the barrier is fixed in position.

10. The siphonic water closet pan of claim 9, wherein the barrier is bonded, welded, or solvent welded in position.

11. The siphonic water closet pan of claim 1, wherein the water inlet is located in an upper portion of the bowl.

12. The siphonic water closet pan of claim 1, wherein the water inlet passage is entirely or partially enclosed within a material of the water closet pan.

13. The siphonic water closet pan of claim 1, wherein the outlet is located in a base portion of the bowl.

14. The siphonic water closet pan of claim 1, wherein the outlet passage is entirely or partially enclosed within a material of the water closet pan.

15. The siphonic water closet pan of claim 1, wherein the refill passage is connectable to a source of water for flushing.

16. The siphonic water closet pan of claim 1, wherein the outlet passage is connectable to a waste pipe.

17. The siphonic water closet pan of claim 1, wherein the smooth convex rim of the bowl is adapted so that it does not provide a purchase point.

18. The siphonic water closet pan of claim 1, wherein the pan is adapted for use without a separate seat.

19. A process for producing a siphonic water closet pan, the process comprising,
a) providing a mold, the components of the mold comprising
i) a bowl former,
ii) a water inlet former configured to form a water inlet connected to water inlet passage to direct water into the bowl for flushing,
iii) an outlet former configured to form an outlet connected to an outlet passage for removal of waste, and
iv) a bypass former configured to form a siphonic bypass connecting the outlet passage and the water inlet passage.
b) filling the mold with a molding composition,
c) curing the molding composition, and optionally
d) disassembling the mold.

20. The process of claim 19, wherein the bypass former comprises a separate siphonic bypass pipe.
